(19) United States
(12) Patent Application Publication
(10) Pub. No.: US 2026/0115881 A1
(43) Pub. Date: Apr. 30, 2026

(54) QUICK-CHANGE CONNECTOR, TOOL HANDLE, AND TOOL ROD

(71) Applicant: Tianjin Jinmao Household Products Co., Ltd, Tianjin (CN)

(72) Inventors: Fengming Li, Tianjin (CN); Jinlong Liu, Tianjin (CN); Longbo Li, Tianjin (CN)

(21) Appl. No.: 19/173,757

(22) Filed: Apr. 8, 2025

(30) Foreign Application Priority Data
Oct. 30, 2024 (CN) 202411527614.5

(51) Int. Cl. B25F 3/00; B25F 5/02

(52) U.S. Cl. CPC B25F 3/00; B25F 5/02

(57) ABSTRACT

The embodiments of the present disclosure provide a quick-change connector, a tool handle, and a tool rod. The quick-change connector is provided with a base body, an inner core assembly arranged inside the base body, a conversion shaft, and a conversion member. When the conversion shaft is at the base body insertion station, each arcuate bump is retracted into an interior of the base body in one-to-one correspondence; and when the conversion shaft is at the threaded connection station of the base body, the conversion shaft expands the inner core assembly, so that each arcuate bump penetrates each window of the accommodation chamber in one-to-one correspondence, so as to form a threaded connection part.

### CROSS-REFERENCE TO RELATED APPLICATION

The present disclosure claims priority to Chinese patent Application No. 2024115276145, filed with the Chinese Patent Office on Oct. 30, 2024, entitled “QUICK-CHANGE CONNECTOR, TOOL HANDLE, AND TOOL ROD”, the entire contents of which are incorporated herein by reference.

### TECHNICAL FIELD

The present disclosure relates to the field of tools, and particularly to a quick-change connector, a tool handle, and a tool rod.

### BACKGROUND ART

For a tool rod capable of switching multiple types of tool heads, it typically includes a universal tool handle. A connector is attached to one end (usually considered to be the front end) in the axial direction of the tool handle. so as to selectively attach different types of tool heads to the tool handle as needed, and then it uses the corresponding tool head for work. There is a wide range of tool heads available for selection. In order to accommodate different working methods, some tool heads need to threadedly connect to the connector at the front end of the tool handle, and some tool heads need to connect the connector at the front end of the tool handle in an insertion method. In the prior art, in order to adapt to the different connection methods of different tool heads, a connector inserted into the tool head and a connector threadedly connected to the tool head are usually arranged on the front end of the tool handle. During use, the connector is selected according to the corresponding connection method of the selected tool head, wherein the connector is first assembled with the tool handle, and then the selected tool head is assembled with the corresponding connector.

### SUMMARY

The embodiments of the present disclosure provide a quick-change connector, a tool handle, and a tool rod adopting the following technical solutions.

In a first aspect, embodiments of the present disclosure provide a quick-change connector, including a base body, an inner core assembly, and a conversion mechanism wherein
the conversion mechanism includes a conversion shaft and a conversion member connected to one end of the conversion shaft;
the inner core assembly includes at least two inner core units and an elastic ring sleeved on an outside of all inner core units, and the elastic ring circumferentially constrains all the inner core units to be circumferentially arrayed around the conversion shaft and butted two by two, wherein an outer peripheral surface of each inner core unit is respectively provided with an arcuate bump extending along a helical direction rotating around the conversion shaft;
the base body includes an accommodation chamber, wherein the accommodation chamber at least passes through an end face of a first end in an axial direction of the base body; the inner core assembly and the conversion shaft are both arranged inside the accommodation chamber; an insertion limiting part is arranged on an outer peripheral surface of the first end in the axial direction of the base body; a plurality of windows are arranged on the outer peripheral surface of the base body, so that each arcuate bump can penetrate out or retract into the accommodation chamber in one-to-one correspondence; and
the conversion member is movably mounted on an exterior of the base body, and can drive the conversion shaft to switch between an insertion station of the base body and a threaded connection station of the base body, so as to be positioned at a current station, wherein when the conversion shaft is at the insertion station of the base body, each arcuate bump is retracted into an interior of the accommodation chamber in one-to-one correspondence; when the conversion shaft is at the threaded connection station of the base body, the conversion shaft overcomes an elastic force of the elastic ring and outwardly expands the inner core assembly in a radial direction, so that each arcuate bump penetrates each window of the accommodation chamber in one-to-one correspondence, so as to form a threaded connection part; and in a radial direction of the base body, a height of the threaded connection part is larger than a height of the insertion limiting part.

In a second aspect, the embodiments of the present disclosure provide a tool handle, including a grip rod and the quick-change connector according to any one of the foregoing embodiments, wherein one end of the grip rod in an axial direction is fixedly connected to a second end of the base body.

In a third aspect, the embodiments of the present disclosure further provide a tool rod, including a first tool head, a second tool head, and the tool handle provided in the foregoing second aspect, wherein the first tool head can be inserted into the first end of the base body when the conversion shaft is at the insertion station of the base body; an inner circumferential surface of one end in an axial direction of the second tool head is provided with an internal thread; and the internal thread can be threadedly connected to a threaded connection part of a first end of the base body when the conversion shaft is at the threaded connection station of the base body.

### BRIEF DESCRIPTION OF DRAWINGS

In order to more clearly illustrate the technical solutions in the embodiments of the present disclosure or in the prior art, the drawings to be used in the description of the embodiments or prior art will be briefly introduced below. It is obvious that the drawings in the following description are some embodiments of the present disclosure. For a person of ordinary skill in the art, other drawings can be obtained based on these drawings without inventive efforts.

FIG. 1 shows a front view of an overall structure of a quick-change connector provided by the embodiments of the present disclosure when a conversion shaft is in an insertion station of the base body;

FIG. 2 shows a top view of an overall structure of a quick-change connector provided by the embodiments of the present disclosure when a conversion shaft is in an insertion station of the base body;

FIG. 3 shows a front sectional view of an overall structure of a quick-change connector provided by the embodiments of the present disclosure when a conversion shaft is in an insertion station of the base body;

FIG. 4 shows a front view of an overall structure of a quick-change connector provided by the embodiments of the present disclosure when a conversion shaft is in a threaded connection station of the base body;

FIG. 5 shows a top view of an overall structure of a quick-change connector provided by the embodiments of the present disclosure when a conversion shaft is in a threaded connection station of the base body;

FIG. 6 shows a front sectional view of an overall structure of a quick-change connector provided by the embodiments of the present disclosure when a conversion shaft is in a threaded connection station of the base body;

FIG. 7 shows an axonometric explosion schematic diagram of an overall structure of a quick-change connector provided by the embodiments of the present disclosure when a conversion shaft is in a threaded connection station of the base body;

FIG. 8 shows an axonometric structure schematic diagram of a first half-housing and a second half-housing of a base body being in a butting state in a quick-change connector provided by the embodiments of the present disclosure;

FIG. 9 shows an inner structure schematic diagram of a first half-housing or a second half-housing of a base body in FIG. 8;

FIG. 10 shows an overall structure schematic diagram of a tool handle provided by the embodiments of the present disclosure;

FIG. 11 shows a front view of an overall structure of a quick-change connector including a support limiting protrusion provided by the embodiments of the present disclosure;

FIG. 12 shows a sectional view of an overall structure of a quick-change connector including a support limiting protrusion provided by the embodiments of the present disclosure;

FIG. 13 shows an explosion schematic diagram of an overall structure of a quick-change connector including a support limiting protrusion provided by the embodiments of the present disclosure;

FIG. 14 shows a schematic diagram of a conversion shaft provided by the embodiments of the present disclosure; and

FIG. 15 shows a schematic diagram of a support limiting protrusion provided by the embodiments of the present disclosure.

Reference numbers: 1—base body; 111—first half—housing; 112—second half—housing; 113—base bolt; 114—positioning ring; 115—first end; 116—second end; 117—mounting hole; 100—accommodation chamber; 110—first accommodation chamber; 120—second accommodation chamber; 101—separator; 102—elastic ring slot; 103—positioning ring slot; 104—bolt through hole; 105—spring positioning part; 11—insertion limiting part; 12—window; 2—inner core assembly; 21—inner core unit; 211—arcuate bump; 212—limiting slot; 22—elastic ring; 221—first elastic ring; 222—second elastic ring; 31—conversion shaft; 311—first shaft section; 312—second shaft section; 313—third shaft section; 32—conversion member; 33—conversion positioning structure; 331—snap protrusion; 332—snap groove; 4—elastic energy storage assembly; 41—baffle plate; 42—inner core bolt; 43—inner core spring; 44—fastening bolt; 5—elastic locking mechanism; 51—press handle; 511—limiting protrusion; 5111—locking pin; 52—rotating pin; 53—press-handle spring; 6—grip rod; 61—quick-locking mechanism; 7—support limiting protrusion; 71—abutting part; and 72—supporting part.

### DETAILED DESCRIPTION OF EMBODIMENTS

In order to make the purpose, technical solutions, and advantages of the embodiments of the present disclosure clearer, the technical solutions in the embodiments of the present disclosure will be described clearly and completely as follows in conjunction with drawings in the embodiments of the present disclosure. It is clear that the embodiments described are only partial embodiments of the present disclosure, and not all of the embodiments. The assembly in embodiments of the present disclosure generally described and shown in the drawings herein can be arranged and designed in various different configurations.

Therefore, the following detailed description of the embodiments of the present disclosure arranged in the drawings is not intended to limit the scope of the present disclosure for which protection is claimed, but only represents selected embodiments of the present disclosure. Based on the embodiments in the present disclosure, all other embodiments obtained by a person of ordinary skill in the art without inventive efforts, shall all fall within the scope of protection of the present disclosure.

It should be noted that similar symbols and letters denote similar items in the drawings. Therefore, once an item has been defined in one of the drawings, it does not need to be further defined and explained in subsequent drawings.

In the description of the present disclosure, it should be noted,
unless other expressly specifications and limitations, the terms “arrange”, “mount”, and “connect” are to be understood in a broad sense, e.g. it can be a fixed connection, a detachable connection, or an integral connection; and it can be a direct connection, an indirect connection through an intermediate medium, or a communication inside two components. For a person of ordinary skill in the art, the specific meaning of the above terms in the present disclosure can be understood according to specific situations.

The orientations or positional relationships indicated by terms, such as “front”, “back”, “inside”, and “outside”, etc., are the orientations or positional relationships based on the drawings, or the orientation or positional relationship that the product of the present disclosure is customarily placed in use, which are only to facilitate the description of the present disclosure and simplify the description, and are not to indicate or imply that the device or element referred to must have a particular orientation, or be constructed and operated with a particular orientation, and therefore cannot to be understood as limitations of the present disclosure.

The terms “first”, “second”, “third”, etc., are used only to distinguish descriptions, do not indicate totals, or relative positions in time and/or space, and cannot be understood to indicate or imply relative importance.

Some embodiments of the present disclosure will be described in detail below in conjunction with the drawings. The following embodiments and features of each optional embodiment in the embodiments can be combined with each other without conflict.

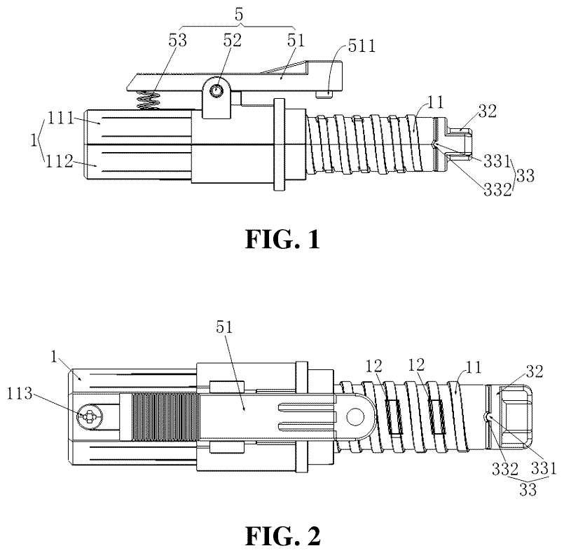

The embodiment provides a quick-change connector, referring to FIG. 1 to FIG. 9, including a base body 1, an inner core assembly 2, and a conversion mechanism. The conversion mechanism includes a conversion shaft 31 and a conversion member 32 connected to one end of the conversion shaft 31. The inner core assembly 2 includes at least two inner core units 21 and an elastic ring 22 sleeved on an outside of all inner core units 21, wherein the elastic ring 22 circumferentially constrains all the inner core units 21 to be circumferentially arrayed around the conversion shaft 31 and butted two by two, and an outer peripheral surface of each inner core unit 21 is respectively provided with an arcuate bump 211 extending along a helical direction rotating around the conversion shaft 31. The base body 1 includes an accommodation chamber 100, wherein the accommodation chamber 100 at least passes through an end face of a first end in an axial direction of the base body 1; the inner core assembly 2 and the conversion shaft 31 are both arranged inside the accommodation chamber 100; an insertion limiting part 11 is arranged on an outer peripheral surface of the first end in the axial direction of the base body 1; a plurality of windows 12 are arranged on the outer peripheral surface of the base body 1, so that each arcuate bump 211 can penetrate out or retract into the accommodation chamber 100 in one-to-one correspondence.

The conversion member 32 is movably mounted on an exterior of the base body 1, and can drive the conversion shaft 31 to switch between an insertion station of the base body 1 and a threaded connection station of the base body 1, so as to be positioned at the current station. When the conversion shaft 31 is at the insertion station of the base body 1, each arcuate bump 211 is retracted into an interior of the accommodation chamber 100 in one-to-one correspondence; when the conversion shaft 31 is at the threaded connection station of the base body 1, the conversion shaft 31 overcomes an elastic force of the elastic ring 22 and outwardly expands the inner core assembly 2 in a radial direction, so that each arcuate bump 211 penetrates each window 12 of the accommodation chamber 100 in one-to-one correspondence, so as to form a threaded connection part; and in a radial direction of the base body 1, a height of the threaded connection part is larger than a height of the insertion limiting part 11.

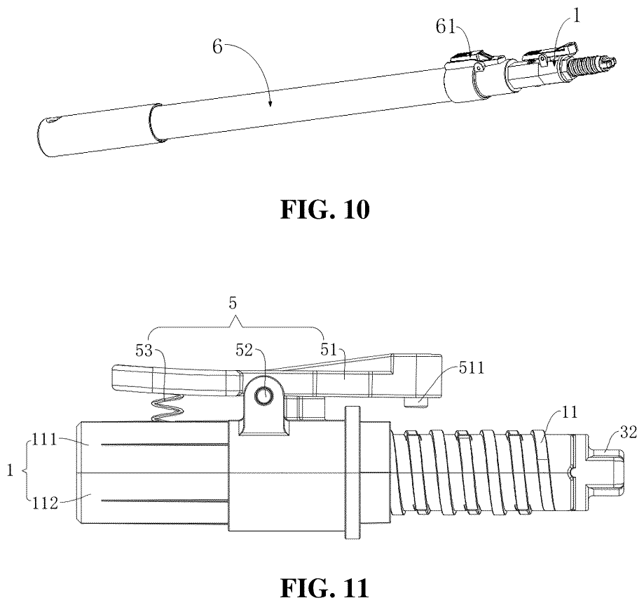

During use, referring to FIG. 10, the first end in the axial direction of the base body 1 in the quick-change connector provided by the embodiment is fixedly connected to one end of the tool handle in the axial direction, so as to form a universal tool handle. When the conversion member 32 is moved relative to the base body 1, the conversion member 32 drives the conversion shaft 31 to switch between the insertion station of the base body 1 and the threaded connection station of the base body 1, so as to be positioned at a current station, so that the function of adapting to two connection methods including the insertion and threaded connections for the tool head is realized by a quick-change connector. In the prior art, as for the structure of the tool rod capable of switching multiple types of tool heads, a tool handle provided with two connectors is used to adapt to tool heads with different connection methods. The present embodiment simplifies the assembly process between different types of tool heads and the tool handle, which is more convenient for the user to use, and solves the problem of the tool rod being unusable due to the loss of the connector.

Optionally, the insertion limiting part 11 arranged on the outer peripheral surface of the first end in the axial direction of the base body 1 is configured to be inserted to the tool head, wherein the insertion limiting part 11 can, but is not limited to, be in the form of the helical protrusions as shown in FIG. 1 to FIG. 9. The helical protrusion is designed to have a smaller height in the radial direction of the base body 1. It provides a certain friction during insertion to prevent the tool head from falling off after insertion. It is to be noted that designing the insertion limiting part 11 as such a helical protrusion structure is only a specific optional structural form of the insertion limiting part 11, and is not a limitation of the structure. For example, but not limited to, optionally, the insertion limiting part 11 can further be a plurality of annular protrusions arranged at intervals in the axial direction of the base body 1, other non-slip textured structures, or other optional structures that can improve the reliability of the insertion.

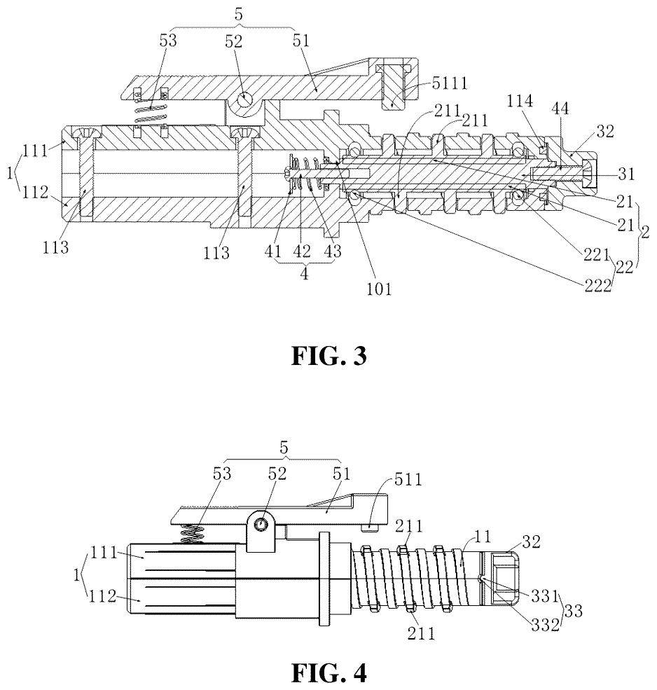

Additionally, optionally, the specific connection method between the conversion member 32 and the conversion shaft 31 includes, but is not limited to, the structures as shown in FIG. 3 and FIG. 6. The two are integrally connected, adhesively bonded, or fixedly connected together by a fastening bolt 44 or other fixing members, so that the conversion shaft 31 can be driven to move when the conversion member 32 moves.

Optionally, for moving the conversion member 32 relative to the base body 1, there are many embodiments for driving the conversion shaft 31 by the conversion member 32, so that the conversion shaft 31 can switch between the insertion station of the base body 1 and the threaded connection station of the base body 1. For example, but not limited to, the conversion shaft 31 is arranged to be a stepped shaft. The conversion shaft 31 is moved relative to the axial direction of the base body 1 by using the conversion member 32. When a part of the conversion shaft 31 with a larger diameter contacts the plurality of inner core assemblies 2, it can overcome the elastic force of the elastic ring 22 and outwardly expand the inner core assembly 2 in the radial direction, so that each arcuate bump 211 penetrates each window 12 of the accommodation chamber 100 of the base body 1 in one-to-one correspondence, so as to form a threaded connection part, which is configured to be threadedly connected to the tool head. When a part of the conversion shaft 31 with a smaller diameter contacts the plurality of inner core assemblies 2, the elastic ring 22 resets, and each arcuate bump 211 correspondingly retracts into the interior of the accommodation chamber 100. The insertion limiting part 11 on the first end in the axial direction of the base body 1 is inserted to the tool head, or other embodiment may be employed.

For ease of manufacture and to improve stability in use, referring to FIG. 1 to FIG. 9, optionally, the inner core assembly 2 includes two inner core units 21. the conversion shaft 31 is a rotary shaft with an elliptical radial section; the conversion member 32 is a knob; and the conversion member 32 can rotate relative to the base body1 to drive the conversion shaft 31 to rotate relative to the base body 1, so as to switch between the insertion station of the base body 1 and the threaded connection station of the base body 1. The structure is simple and easy to manufacture. Further, compared to the design of three or more inner core units 21, the arrangement of two opposing inner core units 21 can solve the problem of structural failure caused by skewing or misalignment between neighboring inner core units 21 when radially expanding or retracting, and thus can improve the optional stability and reliability of the structure in the embodiments of the present disclosure.

Optionally, there are also multiple optional embodiments for the specific positioning method that locates the conversion shaft 31 at the current station after switching the station of the conversion shaft 31 by moving the conversion member 32 relative to the base body 1. For example, but not limited to, a damping pad or a direct friction fit is provided between the conversion shaft 31 and the inner wall of the accommodation chamber 100. When an external force is applied to the conversion shaft 31 by utilizing the conversion member 32, the conversion shaft 31 can move relative to the inner wall of the accommodation chamber 100; and when the external force is removed, the conversion shaft 31 automatically cooperates with the damping pad or the inner wall of the accommodation chamber 100 in a friction method, so as to prevent the conversion shaft 31 from moving to realize the function of positioning at the current station. Alternatively, optionally, a conversion positioning structure 33 is arranged between the conversion member 32 and the base body 1, wherein it can respectively position the conversion member 32 at the current station when the conversion member 32 drives the conversion shaft 31 to the insertion station of the base body 1 and the threaded connection station of the base body 1. The conversion positioning structure 33 has various optional structures, for example, a snap-fit structure on the base body is arranged on the base body 1, wherein it is to open the snap to release the conversion member 32 when it is needed to move the conversion member 32, it is to close the snap to fix the conversion member 32 when it is needed to position the conversion member 32, or other optional embodiments.

When the inner core assembly 2 includes two inner core units 21, wherein the conversion shaft 31 is a rotary shaft with the elliptical radial section; the conversion member 32 is the knob; and the conversion member 32 can rotate relative to the base body1 to drive the conversion shaft 31 to rotate relative to the base body 1, so as to switch between the insertion station of the base body 1 and the threaded connection station of the base body 1. Referring to FIG. 1 to FIG. 9, optionally, the conversion positioning structure 33 includes a snap protrusion 331 arranged on one of the end face of the base body 1 and the conversion member 32 and a snap groove 332 arranged on the other. Optionally, at least two snap protrusions 331 and snap grooves 332 are provided respectively. During positioning, each snap protrusion 331 falls into the corresponding snap groove 332 to realize positioning. Of course, the number of snap protrusions 331 and snap grooves 332 can also be one, three, and four, etc., which is not limited herein.

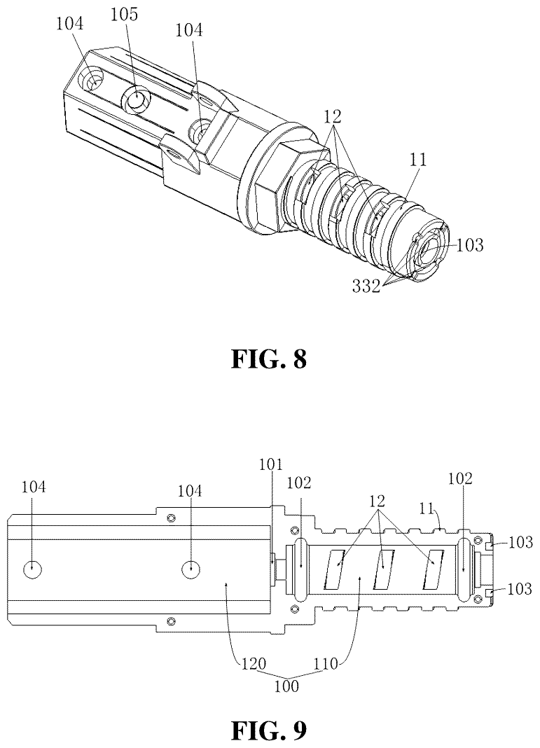

Referring to FIG. 3 and FIG. 6, optionally, the conversion mechanism can further include an elastic energy storage assembly 4, wherein the elastic energy storage assembly 4 can be arranged simultaneously or selectively with the conversion positioning structure 33 formed by the above snap protrusions 331 cooperating with the snap grooves 332. Specifically, in conjunction with FIG. 8 and FIG. 9, a separator 101 is arranged inside the accommodation chamber 100 of the base body 1, so as to divide the accommodation chamber 100 into a first accommodation chamber 110 close to the first end in the axial direction of the base body 1 and the second accommodation chamber 120 close to the second end in the axial direction of the base body 1; the inner core assembly 2 is arranged in the first accommodation chamber 110; the elastic energy storage assembly 4 is arranged in the second accommodation chamber 120; and the elastic energy storage assembly 4 is configured to realize the quick reset for the conversion member 32.

The elastic energy storage assembly 4 includes a baffle plate 41, an inner core bolt 42, and an inner core spring 43. The inner core bolt 42 passes through the baffle plate 41 and the separator 101 and threadedly connects to an end face of the second end of the base body 1. The inner core spring 43 is sleeved on the outside of the inner core bolt 42, wherein one end of the inner core spring 43 abuts against the separator 101, and the other end of the inner core spring 43 abuts against the baffle plate 41. The conversion member 32 can overcome the elastic force of the inner core spring 43 to move towards the first end of the base body 1 relative to the base body 1 from the second end of the base body 1, thereby detaching from the base body 1 and resetting under the elastic force of the inner core spring 43. When it is necessary to rotate the conversion member 32 relative to the base body 1, the conversion member 32 can first be pulled along the axial direction of the base body 1 from its second end toward the first end to overcome the elastic force of the inner core spring 43, so that the conversion member 32 detaches from the base body 1, and the conversion positioning structure 33 is released from the positioning state. At this time, the conversion member 32 is rotated, so as to drive the conversion shaft 31 to finish the switching of station. Under the elastic force of the inner core spring 43, the conversion member 32 resets, and the conversion positioning structure 33 restores the positioning state, thereby realizing the rapid switching and locking of the station.

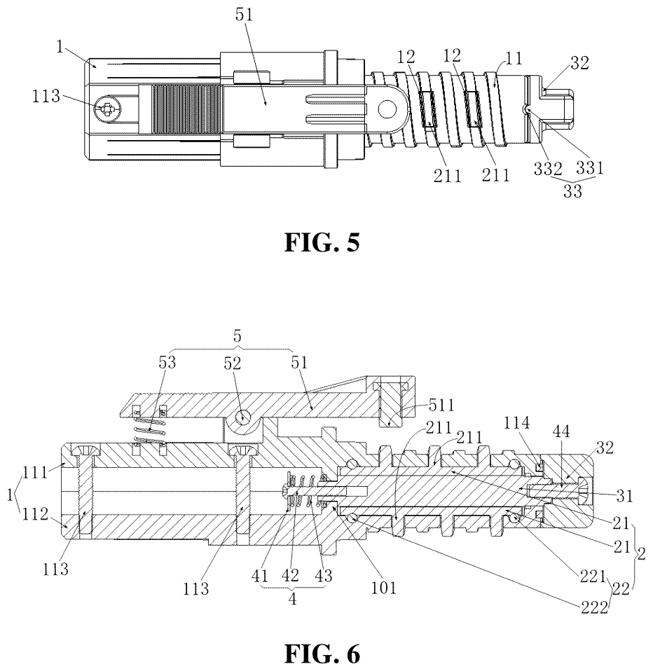

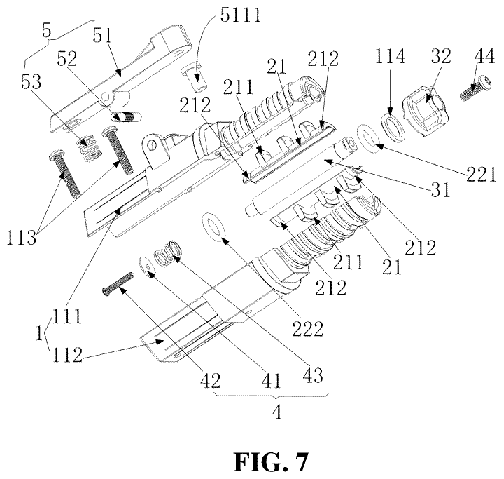

In order to further improve the stability of the embodiment in use and the operational reliability of each structure, optionally, as shown in FIG. 7, a limiting slot 212 configured to axially limit the elastic ring 22 is arranged on the outer peripheral surface of the inner core unit 21. Optionally, as shown in FIG. 3, FIG. 5, and FIG. 7, the elastic ring 22 includes at least a first elastic ring 221 close to one end in the axial direction of the inner core unit 21 and a second elastic ring 222 close to the other end of the axial direction of the inner core unit 21. Additionally, as shown in FIG. 9, an elastic ring slot 102 is arranged on the inner circumferential surface of the base body 1.

Additionally, in order to further enhance the stability of abutting after the first end in the axial direction of the base body 1 is assembled with the tool head, optionally, the base body 1 is further provided with an elastic locking mechanism 5. As shown in FIG. 1 to FIG. 7, the elastic locking mechanism 5 includes a press handle 51, a rotating pin 52, and a press-handle spring 53. The press handle 51 extends along the axial direction of the base body 1, and the middle part of the press handle 51 is rotationally mounted to an outer surface of the base body 1 by the rotating pin 52. The end in the axial direction of the press handle 51 facing the first end of the base body 1 is defined as the front end of the press handle 51; the other end in the axial direction of the press handle 51 is defined as the back end of the press handle 51; and one surface of the press handle 51 facing the base body 1 is defined as the inner side surface of the press handle 51. It satisfies the following: one end of the press-handle spring 53 is fixedly connected to a part on the inner side surface of the press handle 51 close to the back end, and the other end of the press-handle spring 53 is fixedly connected or limitedly connected by the spring positioning part 105 to the outer peripheral surface of the base body 1. The structure of the spring positioning part 105, as shown but not limited to FIG. 7 and FIG. 8, includes a groove arranged on the outer peripheral surface of the base body 1 and a protrusion column arranged inside the groove, so that the other end of the press-handle spring 53 is sleeved on the outside of the protrusion column. The limiting protrusion 511 protruding towards the base body 1 is arranged on a part of the inner side surface of the press handle 51 close to the front end. In this structure, after the tool head abuts against the first end in the axial direction of the base body 1, a part of the tool head is inserted between the front end of the press handle 51 and the outer peripheral surface of the base body 1. Under the action of the elastic restoring force of the press-handle spring 53, the connecting end between the tool head and the base body 1 is compressed by the limiting protrusion 511 of the press handle 51 to further lock the tool head. Optionally, the tool head is configured in a such way that a positioning groove matching to the limiting protrusion 511 is arranged on the outer peripheral surface of the connecting end connecting to the base body 1, so as to prevent the tool head from rotating relative to the base body 1 when the tool head is in use. For the specific structural form of the limiting protrusion 511, it includes, but is not limited to, a structure integrally connected to the inner side surface of the press handle 51, or a locking pin 5111 fixedly mounted in the pin hole at the front end of the press handle 51.

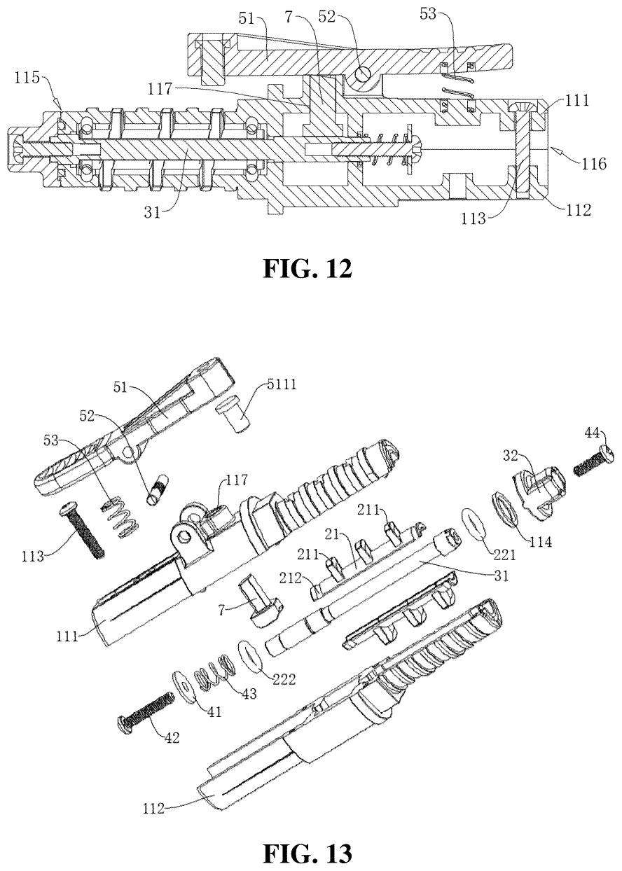

In order to improve the operation convenience of the quick-change connector, optionally, referring to FIG. 11-FIG. 13, the quick-change connector in the embodiment of the present disclosure further includes a support limiting protrusion 7. The base body 1 is provided with a mounting hole 117; the support limiting protrusion 7 is arranged in the mounting hole 117; and one end of the support limiting protrusion 7 abuts against the conversion shaft 31. When the conversion shaft 31 is at the threaded connection station of the base body 1, the support limiting protrusion 7 protrudes out of the mounting hole 117, and the other end of the support limiting protrusion 7 abuts against the inner side surface of the press handle 51. When the conversion shaft 31 is at the insertion station of the base body 1, the support limiting protrusion 7 retracts into the mounting hole 117 and disconnects from the press handle 51.

That is, when the conversion member 32 drives the conversion shaft 31 to rotate so the conversion shaft 31 is at the threaded connection station of the base body 1, the conversion shaft 31 overcomes the elastic force of the elastic ring 22 and outwardly expands the inner core assembly 2 in the radial direction, so that each arcuate bump 211 penetrates each window 12 of the accommodation chamber 100 in one-to-one correspondence, so as to form a threaded connection part. At this time, the support limiting protrusion 7 also protrudes out of the mounting hole 117 to abut against the press handle 51, so that the press handle 51 is kept in a raised state, which facilitates the connection between the accessory and the quick-change connector, so as to improve the convenience for users in use. When the conversion member 32 drives the conversion shaft 31 to rotate, so that the conversion shaft 31 is at the insertion station of the base body 1, each arcuate bump 211 correspondingly retracts into the interior of the accommodation chamber 100. At this time, the support limiting protrusion 7 retracts into the mounting hole 117 under the press action of the press handle 51, so as to realize the synchronous retraction.

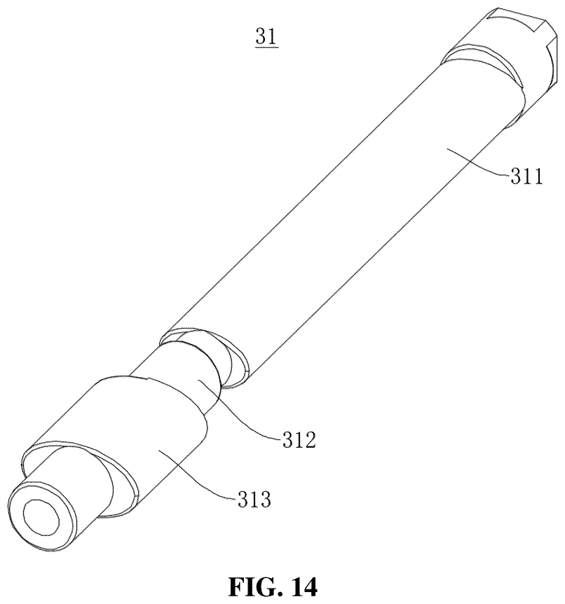

For ease of manufacture and to improve stability in use, referring to FIG. 14, optionally, the conversion shaft includes a first shaft section 311, a second shaft section 312, and a third shaft section 313 connected in sequence, wherein the first shaft section 311 and the third shaft section 313 both are rotary shafts with an elliptical radial section. The conversion member 32 is connected to the first shaft section 311; the elastic ring 22 circumferentially constrains all inner core units 21 to be circumferentially arrayed around the first shaft section 311 and butted two by two; and one end of the support limiting protrusion 7 abuts against the third shaft section 313.

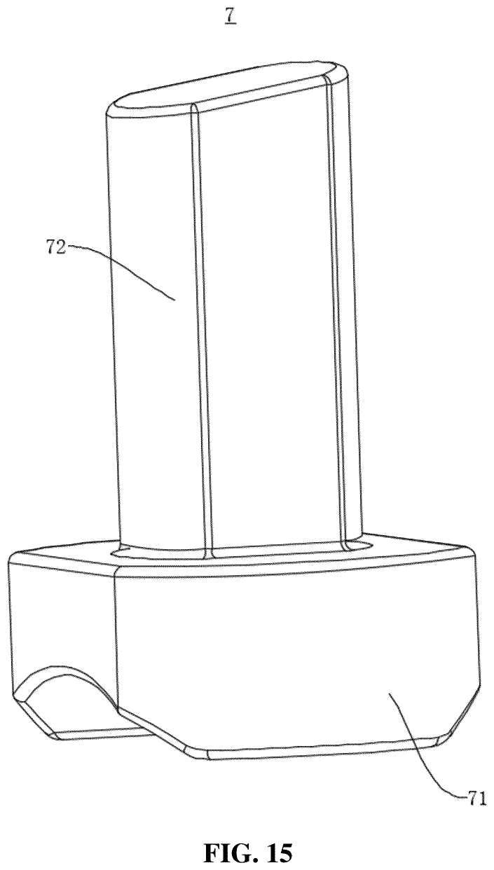

Referring to FIG. 15, in order to improve the stability and tightness between the support limiting protrusion 7 and the third shaft section 313, optionally, the support limiting protrusion 7 in the embodiment of the present disclosure includes an abutting part 71 and a supporting part 72. the abutting part 71 is connected to the supporting part 72; the supporting part 72 is arranged in the mounting hole 117; and the abutting part 71 abuts against the third shaft section 313. The abutting surface of the abutting part 71 with the third shaft section 313 is an arcuate surface. By designing the abutting surface of the abutting part 71 and the third shaft section 313 as the arcuate surface, the contact area between the abutting part 71 and the third shaft section 313 can be increased, thereby ensuring the stability and tightness of the abutting of the support limiting protrusion 7 and the third shaft section 313.

Optionally, according to the motion state of the press handle 51 when it is lifted, the supporting part 72 in the embodiment of the present disclosure has an inclined surface at one end away from the abutting part 71, and the distance from the inclined surface to the axis of the conversion shaft 31 gradually increases along the axial direction of the conversion shaft 31 and in the direction from being close to the press-handle spring 53 to being away from the press-handle spring 53. Of course, the supporting part 72 is designed in other structural shapes according to the motion state of the press handle 51 when it is lifted, which is not limited herein.

Additionally, optionally, the support limiting protrusion 7 can be made of the elastic material, so that it has two states of compression and extension, so as to meet the usage requirement under different working conditions. The conversion shaft 31 can also be designed in other structural forms, wherein it only needs that the extension and retraction of the support limiting protrusion 7 and the arcuate bump 211 can be realized by the conversion shaft 31, which is not limited herein.

Additionally, in order to further facilitate the assembly, optionally, referring to FIG. 1 to FIG. 9, the base body 1 includes a first half-housing 111 and a second half-housing 112 abutting in the radial direction, and the first half-housing 111 and the second half-housing 112 are fixedly connected together by a connecting assembly, wherein the connecting assembly can include, but is not limited to, a base bolt 113 and a positioning ring 114. The first half-housing 111 and the second half-housing 112 are respectively provided with a positioning ring slot 103 and a bolt through hole 104, wherein the positioning ring slot 103 is located on the end face of the first end in the axial direction of the housing; the positioning ring 114 is arranged inside the positioning ring slot 103 to close the axial first end of the first half-housing 111 and the axial first end of the second half-housing 112; the bolt through hole 104 is arranged on the circumferential surface of the second end in the axial direction of the housing; and the base bolt 113 passes through the first half-housing 111 and the second half-housing 112 to fix the first half-housing 111 and the second half-housing 112 together.

The embodiment further provides a tool handle, referring to FIG. 10, wherein the tool handle includes a grip rod 6 and a quick-change connector provided by any one optional embodiment in Embodiment 1. One end of the grip rod 6 in the axial direction is fixedly connected to the second end of the base body 1, wherein the connection method includes, but is not limited to those shown in FIG. 10. By providing a quick-locking mechanism 61 that is the same as or similar to the elastic locking mechanism 5 in the embodiment, after inserting the second end in the axial direction of the base body 1 of the quick-change connector into one end of the grip rod 6 axial direction, the base body 1 of the quick-change connector is locked to the grip rod 6.

The embodiment further provides a tool rod, wherein the tool rod includes a first tool head, a second tool head, and a tool handle provided by Embodiment 2. The first tool head can be inserted into the first end of the base body 1 when the conversion shaft 31 is at the insertion station of the base body 1; an inner circumferential surface of one end in an axial direction of the second tool head is provided with an internal thread; and the internal thread can be threadedly connected to the threaded connection part of the first end of the base body 1 when the conversion shaft 31 is at the threaded connection station of the base body 1.

Since the tool handle provided in Embodiment 2 and the tool rod provided in Embodiment 3 both include the quick-change connector described in Embodiment 1, the tool handle and tool rod provided in the embodiment can achieve all beneficial effects of the quick-change connector in Embodiment 1, and the specific structure and achievable effects can refer to various optional embodiments in Embodiment 1.

Finally, it should be noted that: the above embodiments and their optional embodiments in the specification are used only to illustrate the technical solution of the present disclosure, and not to limit it. Although the present disclosure is described in detail with reference to each foregoing embodiments, it should be understood by persons of ordinary skill in the art that they may still modify the technical solutions described in the foregoing optional embodiments or make equivalent substitutions for some or all of the technical features; and these modifications or substitutions do not take the essence of the corresponding technical solutions out of the scope of the technical solutions in each embodiment of the present disclosure. Moreover, it is noted again: the embodiments and features of each optional embodiment in the embodiments in the specification can be combined with each other without conflict.

### INDUSTRIAL APPLICABILITY

In summary, the embodiments of the present disclosure provide a quick-change connector, a tool handle, and a tool rod. It simplifies the assembly process between different types of tool heads and the tool handle, which is more convenient for the user to use, and solves the problem of the tool rod being unusable due to the loss of the connector.

1. A quick-change connector, comprising a base body, an inner core assembly, and a conversion mechanism, wherein
the conversion mechanism comprises a conversion shaft and a conversion member connected to one end of the conversion shaft;
the inner core assembly comprises at least two inner core units and an elastic ring sleeved on an outside of all the inner core units, and the elastic ring circumferentially constrains all the inner core units to be circumferentially arrayed around the conversion shaft and butted two by two, wherein an outer peripheral surface of each of the inner core units is respectively provided with an arcuate bump extending along a helical direction rotating around the conversion shaft;
the base body comprises an accommodation chamber, wherein the accommodation chamber at least passes through an end face of a first end in an axial direction of the base body; the inner core assembly and the conversion shaft are both arranged inside the accommodation chamber; an insertion limiting part is arranged on an outer peripheral surface of the first end in the axial direction of the base body; a plurality of windows are arranged on an outer peripheral surface of the base body, so that each of the arcuate bumps can penetrate out or retract into the accommodation chamber in one-to-one correspondence; and
the conversion member is movably mounted on an exterior of the base body, and can drive the conversion shaft to switch between an insertion station of the base body and a threaded connection station of the base body, so as to be positioned at a current station, wherein when the conversion shaft is at the insertion station of the base body, each of the arcuate bumps is retracted into an interior of the accommodation chamber in one-to-one correspondence; when the conversion shaft is at the threaded connection station of the base body, the conversion shaft overcomes an elastic force of the elastic ring and outwardly expands the inner core assembly in a radial direction, so that each of the arcuate bumps penetrates each of the windows of the accommodation chamber in one-to-one correspondence, so as to form a threaded connection part; and in a radial direction of the base body, a height of the threaded connection part is larger than a height of the insertion limiting part.

2. The quick-change connector according to claim 1, wherein the inner core assembly comprises two inner core units; the conversion shaft is a rotary shaft with an elliptical radial section; the conversion member is a knob; and the conversion member can rotate relative to the base body to drive the conversion shaft to rotate relative to the base body, so as to switch between the insertion station of the base body and the threaded connection station of the base body.

3. The quick-change connector according to claim 2, wherein a conversion positioning structure is arranged between the conversion member and the base body, wherein the conversion positioning structure can respectively position the conversion member at the current station when the conversion member drives the conversion shaft to the insertion station of the base body and the threaded connection station of the base body.

4. The quick-change connector according to claim 3, wherein the conversion positioning structure comprises a snap protrusion arranged on one of an end face of the base body and the conversion member and a snap groove arranged on the other.

5. The quick-change connector according to claim 2, wherein the conversion mechanism further comprises an elastic energy storage assembly, wherein
a separator is arranged inside the accommodation chamber of the base body, so as to divide the accommodation chamber into a first accommodation chamber close to the first end in the axial direction of the base body and a second accommodation chamber close to a second end in the axial direction of the base body; the inner core assembly is arranged in the first accommodation chamber; the elastic energy storage assembly is arranged in the second accommodation chamber; and the elastic energy storage assembly is configured to realize a quick reset for the conversion member.

6. The quick-change connector according to claim 5, wherein the elastic energy storage assembly comprises a baffle plate, an inner core bolt, and an inner core spring, wherein
the inner core bolt passes through the baffle plate and the separator and threadedly connects to an end face of the second end of the base body;
the inner core spring is sleeved on an outside of the inner core bolt, wherein one end of the inner core spring abuts against the separator, and the other end of the inner core spring abuts against the baffle plate; and the conversion member can overcome an elastic force of the inner core spring to move towards the first end of the base body relative to the base body from the second end of the base body, thereby detaching from the base body and resetting under an elastic force of the inner core spring.

7. The quick-change connector according to claim 1, wherein a limiting slot configured to axially limit the elastic ring is arranged on an outer peripheral surface of the inner core unit; and/or
the elastic ring at least comprises a first elastic ring close to one end in an axial direction of the inner core unit and a second elastic ring close to the other end in the axial direction of the inner core unit.

8. The quick-change connector according to claim 1, wherein the base body is further provided with an elastic locking mechanism, wherein
the elastic locking mechanism comprises a press handle, a rotating pin, and a press-handle spring, wherein
the press handle extends along the axial direction of the base body, and a middle part of the press handle is rotationally mounted to an outer surface of the base body by the rotating pin, wherein one end in an axial direction of the press handle facing a first end of the base body is defined as a front end of the press handle; the other end in the axial direction of the press handle is defined as a back end of the press handle; and one surface of the press handle facing the base body is defined as an inner side surface of the press handle, satisfying:
one end of the press-handle spring is fixedly connected to a part on the inner side surface of the press handle close to the back end; the other end of the press-handle spring is fixedly connected or limitedly connected to the outer peripheral surface of the base body; and a limiting protrusion protruding towards the base body is arranged on a part of the inner side surface of the press handle close to the front end.

9. The quick-change connector according to claim 8, wherein the quick-change connector further comprises a support limiting protrusion; the base body is provided with a mounting hole; the support limiting protrusion is arranged in the mounting hole; and one end of the support limiting protrusion abuts against the conversion shaft, wherein
when the conversion shaft is at the threaded connection station of the base body, the support limiting protrusion protrudes out of the mounting hole, and the other end of the support limiting protrusion abuts against the inner side surface of the press handle; and when the conversion shaft is at the insertion station of the base body, the support limiting protrusion retracts into the mounting hole and disconnects from the press handle.

10. The quick-change connector according to claim 9, wherein the conversion shaft comprises a first shaft section, a second shaft section, and a third shaft section connected in sequence, wherein the first shaft section and the third shaft section both are rotary shafts with an elliptical radial section; the conversion member is connected to the first shaft section; the elastic ring circumferentially constrains all of the inner core units to be circumferentially arrayed around the first shaft section and butted two by two; and
one end of the support limiting protrusion abuts against the third shaft section.

11. The quick-change connector according to claim 10, wherein the support limiting protrusion comprises an abutting part and a supporting part, wherein the abutting part is connected to the supporting part; the supporting part is arranged in the mounting hole; the abutting part abuts against the third shaft section; and an abutting surface of the abutting part with the third shaft section is an arcuate surface.

12. The quick-change connector according to claim 11, wherein one end of the supporting part away from the abutting part is provided with an inclined surface, and a distance from the inclined surface to an axis of the conversion shaft gradually increases along an axial direction of the conversion shaft and in a direction from being close to the press-handle spring to being away from the press-handle spring.

13. The quick-change connector according to claim 1, wherein the base body comprises a first half-housing and a second half-housing abutting in a radial direction.

14. The quick-change connector according to claim 13, wherein the first half-housing and the second half-housing are fixedly connected together by a connecting assembly.

15. The quick-change connector according to claim 1, wherein a damping pad is arranged between the conversion shaft and an inner wall of the accommodation chamber.

16. A tool handle, comprising a grip rod and the quick-change connector according to claim 1, wherein one end of the grip rod in an axial direction is fixedly connected to a second end of the base body.

17. A tool rod, comprising a first tool head, a second tool head, and the tool handle according to claim 16, wherein the first tool head can be inserted into a first end of the base body when the conversion shaft is at an insertion station of the base body; an inner circumferential surface of one end in an axial direction of the second tool head is provided with an internal thread; and the internal thread can be threadedly connected to a threaded connection part of a first end of the base body when the conversion shaft is at a threaded connection station of the base body.
